(19) United States
(12) Patent Application Publication
(10) Pub. No.: US 2024/0369380 A1
(43) Pub. Date: Nov. 7, 2024

(54) FLUX-COLLECTING ELEMENT AND COLLECTOR UNIT OF A MAGNETIC POSITION SENSOR AND METHOD FOR THE PRODUCTION THEREOF

(71) Applicants: thyssenkrupp Presta AG, Eschen (LI); thyssenkrupp AG, Essen (DE)

(72) Inventor: Simon DREHER, Buchs (CH)

(73) Assignees: thyssenkrupp Presta AG, Eschen (LI); thyssenkrupp AG, Essen (DE)

(21) Appl. No.: 18/683,743

(22) PCT Filed: Aug. 8, 2022
(86) PCT No.: PCT/EP2022/072184

§ 371 Date: Feb. 14, 2024

(30) Foreign Application Priority Data
Aug. 18, 2021 (DE) 10 2021 209 048.6

(51) Int. Cl. G01D 5/14; H01F 3/02; H01F 41/02

(52) U.S. Cl. CPC G01D 5/145; H01F 3/02; H01F 41/024; G01D 2205/40

(57) ABSTRACT

A flux collection element of a collector unit of a magnetic position sensor and a method of producing the flux collection element, wherein the flux collection element comprises a first collection zone in a first plane and a second collection zone in a second plane, and wherein there is a connection between the first collection zone and the second collection zone via a magnetically conductive connection portion between a first attachment edge of the first collection zone and a second attachment edge of the second collection zone. In particular so that the flux collection element can thus be handled as a bulk product, the connection between the first collection zone and the second collection zone is mechanically stiffened, in particular by the introduction of a bead to be used in an electromechanical steering system in which a torque acting on a steering shaft of the steering system is detected by means of such a magnetic position sensor.

The invention relates to a flux collection element of a collector unit of a magnetic position sensor, which comprises a first collection zone and a second collection zone. The first collection zone is arranged in a first plane and has a first attachment edge and the second collection zone is arranged in a second plane and has a second attachment edge. There is a connection here between the first collection zone and the second collection zone via a magnetically conductive connection portion between the first attachment edge and the second attachment edge. The invention also relates to a method for producing a flux collection element. The invention also relates to a collector unit of a magnetic position sensor with two flux collection elements, a magnetic position sensor with a collector unit comprising two flux collection elements and an electromechanical steering system which comprises such a magnetic position sensor for detecting torques applied to a steering shaft of the steering system.

In the prior art, magnetic position sensors are known in particular as magnetic torque sensor devices from EP 2 664 906 A2 and WO 2017/115922 A1. The torque sensor devices disclosed there have a multi-pole magnetic ring, a stator ring element and a collector unit with two flux collection elements, wherein a magnetosensitive sensor element, in particular a Hall sensor, is arranged between the flux collection elements. Each of the flux collection elements of the collector unit has a collection zone through which a magnetic flux is conducted that depends on the position of the magnetic ring relative to the stator ring element. The magnetic flux is detected here by the magnetosensitive sensor element, wherein a position or a torque can be determined from an evaluation of the signal detected by the magnetosensitive sensor element.

The disadvantage of this is that the collection zone not only detects the useful magnetic field from the magnetic ring, but also interference magnetic fields, which can be caused by the earth's magnetic field, but also by electrical currents that flow in the vicinity of the magnetic position sensor, for example in a motor vehicle for operating electric motors. These interfering magnetic fields have a detrimental effect on the determination of a position or a torque from the signal detected by the magnetosensitive sensor element and can lead to incorrect determinations.

A further-developed magnetic position sensor is known from WO 2020/174170 A1 for reducing the influence of interference magnetic fields. In this case, the collector unit has two flux collection elements, each comprising a first collection zone and a second collection zone. The first collection zone is arranged in a first plane and has a first attachment edge and the second collection zone is arranged in a second plane parallel to the first plane and has a second attachment edge. There is a connection between the first collection zone and the second collection zone via a magnetically conductive connection portion between the first attachment edge and the second attachment edge. The flux collection elements are arranged to form a collector unit in such a way that the first collection zone and the second collection zone of the flux collection elements are opposite each other. The second collection zones are located outside the magnetic ring-stator arrangement. In this respect, as before, a magnetic flux resulting from a superposition of the useful magnetic field and possible interference magnetic fields is collected with the first collection zones. In addition, however, the second collection zones of the collector unit now collect a magnetic flux that substantially results exclusively from the possible interference magnetic fields. However, since the first collection zone and the second collection zone of a respective flux collection element are arranged in different planes, the interference magnetic field between the first collection zones of the flux collection elements and the second collection zones of the flux collection elements acts with a different sign. For a magnetosensitive sensor element arranged substantially centrally between the collection zones, the interference magnetic field components detected by the first collection zones and the second collection zones are therefore annihilated and substantially only the magnetic flux of the useful magnetic field is detected.

The disadvantage of these further-developed magnetic position sensors is that the flux collection elements are more complex, which makes the flux collection elements more sensitive to deformation. This means that more effort has to be put into the production and transportation of the flux collection elements in order to avoid deformations that would lead to functional impairment. However, this also leads to an increase in costs. In addition, the two flux collection elements are designed differently in order to ensure that the first collection zones and the second collection zones in one collector unit are arranged one above the other in different planes. Since therefore not only one type of flux collection element has to be produced, but two different types of flux collection elements have to be produced, the further-developed magnetic position sensor according to WO 2020/174170 A1 is associated with a further increase in costs compared to the previously known magnetic position sensors.

Against this background, it is an object of the present invention to provide a magnetic position sensor with a collector unit comprising a first flux collection element and a second flux collection element each with a first collection zone and a second collection zone, in particular as described in WO 2020/174170 A1, at a lower cost, and thus advantageously also to be able to provide an electromechanical steering system with such a magnetic position sensor at a lower cost.

To solve this problem, a flux collection element, a method for producing a flux collection element, a collector unit, a magnetic position sensor and an electromechanical steering system are proposed in accordance with the independent claims. Further advantageous embodiments of the invention are described in the dependent claims and the description and are shown in the figures.

The proposed solution provides a flux collection element of a collector unit of a magnetic position sensor, wherein the flux collection element comprises a first collection zone and a second collection zone, wherein the first collection zone is arranged in a first plane and has a first attachment edge, wherein the second collection zone is arranged in a second plane and has a second attachment edge, wherein a connection is formed between the first collection zone and the second collection zone via a magnetically conductive connection portion between the first attachment edge and the second attachment edge, and the connection is mechanically reinforced. The reinforcement is preferably represented by a pressed-in bead.

In particular, the second plane is preferably a plane that is different from the first plane. Preferably, the first plane and the second plane are parallel to each other. Advantageously, there is a height offset between the first collection zone and the second collection zone. In particular, the first collection zone and the second collection zone do not overlap, which means that the first collection zone lies outside the vertical projection surface of the second collection zone. There is a connection between the first collection zone and the second collection zone via a magnetically conductive connection portion between the first attachment edge and the second attachment edge. In particular, the first collection zone and the second collection zone are spaced apart by the connection portion in the longitudinal direction of extent of the flux collection element. In particular, from a side view, the connection portion runs at least partially diagonally with respect to the first collection zone and with respect to the second collection zone. According to one variant, the connection portion comprises horizontal and vertical portions. The connection between the first collection zone and the second collection zone is advantageously mechanically reinforced. In particular, an alignment of the first collection zone in relation to an alignment of the second collection zone is stabilized by a reinforcement of the connection, in particular stabilized against bending of the first collection zone relative to the second collection zone. In particular, the mechanical reinforcement prevents bending due to mutual contact between a plurality of flux collection elements, for example when the flux collection elements are transported as bulk products during mass production and/or are collected as bulk products in receiving containers. Mechanical reinforcement thus reduces waste and simplifies the handling of the flux collection elements, making it more cost-effective. Mechanical reinforcement advantageously enables the flux collection elements to be handled as bulk products in the first place. The mechanical reinforcement is advantageously designed in such a way that bending of the first collection zone along the first attachment edge is prevented and bending of the second collection zone along the second attachment edge is prevented. Furthermore, the mechanical reinforcement is advantageously designed in such a way that twisting of the first collection zone about the first attachment edge is prevented and twisting of the second collection zone about the second attachment edge is prevented.

A further advantageous design of the flux collection element is that the first collection zone, the second collection zone and the connection portion are formed together in one piece, in particular from a soft-magnetic sheet metal. The one-piece design of the flux collection element has a cost-reducing effect on the production costs. In addition, the handling of the flux collection element is advantageously simplified.

In particular, it is provided that the connection between the first collection zone and the second collection zone is mechanically reinforced by a reshaping process, in particular by pressing. It is further provided in particular that the entire flux collection element, comprising the first collection zone and the second collection zone and the connection portion, is produced by a reshaping process, in particular by pressing, preferably in a single production step. Preferably, manufacture takes place in a bending-and-stamping operation.

Advantageously, the connection between the first collection zone and the second collection zone is mechanically reinforced in that the first collection zone is arranged in the first plane by a cold deformation process and/or the second collection zone is arranged in the second plane by a cold deformation process. In particular, it is provided that the first collection zone is arranged in the first plane by a folding process as the cold deformation process and/or the second collection zone is arranged in the second plane by a folding process as the cold deformation process.

The connection between the first collection zone and the second collection zone is particularly advantageously mechanically reinforced by at least one bead. A bead is a depression, in particular a channel-shaped depression. In particular, the bead can also be referred to in the present case as an embossing, as the bead is driven into the sheet metal of the flux collection element. The at least one bead advantageously achieves a stability which, in particular, prevents the first collection zone and the second collection zone from bending relative to one another, in particular when the flux collection elements are transported and/or stored as bulk products.

According to a further advantageous embodiment, a bead extends over the connection portion and over the first attachment edge into a first attachment region of the first collection zone and over the second attachment edge into a second attachment region of the second collection zone. Advantageously, this achieves a high degree of stability and reinforcement against deformation of the collection zones.

A further advantageous embodiment provides for a bead at each reshaping point of the flux collection element. In particular, each bending edge has at least one bead. In particular, a transition region between the first collection zone and the connection portion has at least one bead. Further in particular, a transition region between the second collection zone and the connection portion has at least one bead. If the connection portion is designed such that a bending edge exists at least between a first portion of the connection portion and a second portion of the connection portion, it is furthermore provided in particular that a transition region between the first portion and the second portion has at least one bead.

In particular, the mechanical reinforcement is formed as a bead.

According to a further embodiment option, it is provided that the connection portion of the flux collection element comprises a plurality of connection elements. In particular, it is envisaged that the connection portion is at least partially formed as a truss structure, wherein the bars of the truss are the connection elements. The truss structure advantageously further mechanically reinforces the flux collection element. In particular, it may also be provided that the connection elements of the connection portion each form a connection portion between the first collection zone and the second collection zone. The connection elements advantageously create further freedom in the design of the flux collection element and increase its adaptability.

According to a further particularly advantageous embodiment of the flux collection element, it is provided that the connection portion is asymmetrical with respect to a center position of the first attachment edge and a center position of the second attachment edge, in particular such that a first flux collection element can form a collector unit together with a second flux collection element which is rotated by 180° with respect to the first flux collection element. Since the connection portion of the respective flux collection element is asymmetrical with respect to a center position of the first attachment edge and a center position of the second attachment edge, the connection portion of the first flux collection element and the connection portion of the second flux collection element can be arranged next to each other. Advantageously-in contrast to the flux collection elements disclosed in WO 2020/174170 A1-a collector unit can be formed with structurally identical flux collection elements. Since only one type of flux collection element has to be manufactured in this respect, there are significant cost advantages.

In particular, a particularly advantageous embodiment of the invention provides a flux collection element of a collector unit of a magnetic position sensor, wherein the flux collection element comprises a first collection zone and a second collection zone, the first collection zone is arranged in a first plane and has a first attachment edge, the second collection zone is arranged in a second plane and has a second attachment edge, wherein a connection between the first collection zone and the second collection zone exists via a magnetically conductive connection portion between the first attachment edge and the second attachment edge, and wherein the connection portion is asymmetrical with respect to a center position of the first attachment edge and a center position of the second attachment edge. Advantageously, the connection is mechanically reinforced, as explained above.

It is further advantageously provided that the first collection zone and the second collection zone are symmetrical and therefore in particular have the same size.

In particular, it is provided that the width of the connection portion in the region of the first attachment edge is between 10% and 50% of the length of the first attachment edge and/or that the width of the connection portion in the region of the second attachment edge is between 10% and 50% of the length of the second attachment edge. In particular, it is provided that the length of the first attachment edge is equal to the length of the second attachment edge.

Further advantageously, the connection portion is connected to the first collection zone between a first end of the first attachment edge and the center position of the first attachment edge and is connected to the second collection zone between a second end of the second attachment edge and the center position of the second attachment edge. Such an embodiment advantageously permits uniform mechanical reinforcement of the connection between the first collection zone and the second collection zone, in particular if the connection portion has a constant width, which is provided according to a particularly advantageous embodiment. An advantageous embodiment provides that the first end of the first attachment edge and the second end of the second attachment edge are ends of the respective attachment edge arranged on the same side of the flux collection element. One variant in this regard provides that the first end of the first attachment edge and the second end of the second attachment edge are diagonally opposite each other, so that the connection portion advantageously extends diagonally between the first collection zone and the second collection zone. Advantageously, this can further increase the rigidity of the connection.

According to a further advantageous embodiment of the flux collection element, the flux collection element comprises a receiving unit for at least one magnetosensitive sensor element, in particular for at least one Hall element of a Hall sensor. Advantageously, the receiving unit is arranged between the first collection zone and the second collection zone in such a way that the second collection zone forms a magnetic field reversal zone with respect to the first collection zone, in particular when the flux collection element forms a collector unit with a further flux collection element. In particular, it is provided that the receiving unit is next to the connection portion between the first collection zone and the second collection zone. Preferably, the first collection zone, the second collection zone, the connection portion and the receiving unit are formed together in one piece. In particular, the receiving unit is arranged such that a magnetosensitive element received by the receiving unit can detect a magnetic flux emanating from the first collection zone and the second collection zone.

Furthermore, a method for producing a flux collection element is proposed for solving the problem, which comprises the following steps: providing a sheet-metal element made of a soft-magnetic material; reshaping the provided sheet-metal element in a bending-and-stamping operation into the finished form of the flux collection element, wherein during the bending-and-stamping operation at least one bead is introduced as strengthening into one of the surfaces and/or one of the bent portions of the flux collection element. A bending-and-stamping operation is to be understood as a manufacturing operation in which reshaping steps and separation steps, for example in the form of punching operations, are integrated in one work step.

In particular, a flux collection element as described above, comprising a first collection zone in a first plane, a second collection zone in a second plane and a connection portion via which a connection exists between the first collection zone and the second collection zone; and mechanical reinforcement of the connection can be produced in a few reshaping steps or steps of a bending-and-stamping operation. Preferably, the one-piece flux collection element is formed in a single step in a bending-and-stamping operation. In particular, it is provided that the step of mechanically reinforcement the connection provides for the introduction of at least one bead into the sheet-metal element, in particular in each case at the reshaping edges. Advantageously, a bead is introduced into the connection over the entire extent of the connection potion. The mechanical reinforcement step also advantageously involves the introduction of folded edges.

The flux collection element produced according to the method is advantageously formed in one piece from the sheet-metal element provided.

It is further advantageously provided that the steps of applying a separation process and reshaping the sheet-metal element are carried out together in a bending-and-stamping operation. Advantageously, the process can be carried out even more cost-effectively in this way. Advantageously, the step of mechanically reinforcement the connection is also carried out during the bending-and-stamping operation, in particular by introducing at least one bead as strengthening into a surface of the flux collection element and/or a reshaped portion of the flux collection element during the bending-and-stamping operation, in particular such that an alignment of the first collection zone with respect to the alignment of the second collection zone is stabilized by the introduction of the at least one bead, in particular when handling the produced flux collection element as a bulk product.

According to an advantageous development of the method, the following further method step is provided: Annealing the flux collection element at a temperature that neutralizes the magnetic structure of the reshaped flux collection element. This can advantageously improve the measurement accuracy with later use in a magnetic position sensor. The temperature for the annealing process should be higher than 850° C., in particular higher than 1100° C. The annealing process of the flux collection element is preferably carried out for longer than 2 hours, in particular longer than 3 hours. It is advantageous if temperatures of 1600° C. are not exceeded during the annealing process. The annealing process of the flux collection element is advantageously carried out under vacuum or in a neutral atmosphere or a decarburizing hydrogen atmosphere. The cooling rate is advantageously less than 150° C. per hour, in particular less than 100° C. per hour, until the flux collection element has reached the Curie temperature of about 450° C.

Advantageously, the method for producing the flux collection element is applied in such a way that the first region for forming the first collection zone and the second region for forming the second collection zone are of the same size. In particular, the first collection zone and the second collection zone each form rectangular surfaces.

The sheet-metal element is advantageously formed in such a way that the first collection zone is arranged in a first plane and the second collection zone is arranged in a second plane, wherein the first plane is parallel to the second plane and the first plane and the second plane are spaced apart from one another. In particular, the sheet-metal element is formed in such a way that the first collection zone and the second collection zone do not overlap, i.e., the first collection zone lies in particular outside the vertical projection surface of the second collection zone. The edge of the first collection zone, at which the connection portion is arranged, is referred to as the first attachment edge, and the edge of the second collection zone, at which the connection portion is arranged, is referred to as the second attachment edge.

Further advantageously, the production method is applied in such a way that the connection portion is asymmetrical with respect to a center position of the first attachment edge and a center position of the second attachment edge. The separation is further advantageously carried out in such a way that the width of the connection portion in the region of the first attachment edge is between 10% and 50% of the length of the first attachment edge and/or that the width of the connection portion in the region of the second attachment edge is between 10% and 50% of the length of the second attachment edge. In particular, the separation method is further applied such that the connection portion is connected to the first collection zone between a first end of the first attachment edge and the center position of the first attachment edge and is connected to the second collection zone between a second end of the second attachment edge and the center position of the second attachment edge. The first end of the first attachment edge and the second end of the second attachment edge are advantageously ends of the respective attachment edge arranged on the same side of the flux collection element. Alternatively, it can be provided that the first end of the first attachment edge and the second end of the second attachment edge are diagonally opposite each other.

A further advantageous embodiment of the method provides that when the separation process, in particular the punching, is applied to the sheet-metal element provided, a fourth region is created to form a receiving unit for at least one magnetosensitive sensor element. The sheet-metal element is advantageously formed with the fourth region such that the receiving unit is arranged between the first collection zone and the second collection zone, preferably such that the second collection zone forms a magnetic field reversal zone with respect to the first collection zone. In particular, the reshaping takes place in such a way that the receiving unit is next to the connection portion between the first collection zone and the second collection zone.

To solve the problem mentioned at the outset, a collector unit of a magnetic position sensor is further proposed, which comprises a first flux collection element and a second flux collection element, wherein the first flux collection element and the second flux collection element are formed according to one of the aforementioned embodiments and/or are produced according to a method as described above. Thus, the proposed collector unit of a magnetic position sensor comprises a first flux collection element formed according to the invention and a second flux collection element formed according to the invention. In particular, the first flux collection element and/or the second flux collection element are produced according to a method described above. According to a preferred embodiment, the first flux collection element and the second flux collection element are structurally identical. This allows the collector unit to be produced more cost-effectively. Advantageously, two different types of flux collection elements do not have to be kept in stock, which leads to further cost advantages. For this purpose, the connection portion of the first flux collection element and the connection portion of the second flux collection element are advantageously asymmetrical with respect to a center position of the respective first attachment edge and a center position of the respective second attachment edge. In particular, the connection portion of the respective flux collection element is connected to the first collection zone of the respective flux collection element between a first end of the first attachment edge and the center position of the first attachment edge and/or is connected to the second collection zone between a second end of the second attachment edge and the center position of the second attachment edge. The connection portion of the second flux collection element is then inserted into the free space that exists next to the connection portion of the first flux collection element when the collector unit is created, advantageously by arranging the first flux collection element and the second flux collection element rotated by 180° with respect to a direction of longitudinal extent of the flux collection elements relative to one another. The collector unit created in this way then comprises a first flux collection element and a second flux collection element structurally identical to the first flux collection element, wherein the first flux collection element and the second flux collection element are arranged rotated by 180° relative to one another with respect to a direction of longitudinal extent of the flux collection elements.

The magnetic position sensor furthermore proposed for solving the problem stated at the outset comprises a multi-pole magnetic ring, a stator ring element, at least one magnetosensitive sensor element, in particular a Hall sensor, and a collector unit formed according to the invention. In particular, the magnetic position sensor—except for the flux collection elements of the collector unit-can be designed according to one of the embodiments as described in WO 2020/174170 A1. The flux collection elements formed according to the invention, which are advantageously structurally identical, advantageously provide a more cost-effective magnetic position sensor than in WO 2020/174170 A1.

Lastly, the electromechanical steering system proposed for solving the problem stated at the outset further comprises a steering shaft, via which a steering command can be specified by means of a steering handle, in particular by means of a steering wheel, and also comprises a steering gear, which is designed to convert a steering command into a steering movement of steerable wheels of a motor vehicle, taking into account at least one input variable, and a magnetic torque sensor device for measuring a torque applied to the steering shaft, in particular a magnetic position sensor proposed according to the invention. The steering shaft of the steering system has an input shaft that can be connected for conjoint rotation to a steering handle and an output shaft connected to the input shaft via a torsion bar that can be twisted. A multi-pole magnetic ring of the torque sensor device for generating a magnetic field is connected to the input shaft for conjoint rotation. A stator ring element of the torque sensor device, which is connected to the output shaft for conjoint rotation, surrounds the magnetic ring. A magnetic flux collector unit arranged on the stator ring element comprises at least one magnetosensitive sensor element, in particular at least one Hall sensor, wherein the at least one magnetosensitive sensor element is designed to provide a measurement signal based on a magnetic field applied to the magnetic flux collector unit. The measurement signal can then be evaluated, in particular by a computing unit assigned to the steering system and, in particular, a torque can be determined from it. The magnetic flux collector unit of the torque sensor device is formed here as a collector unit according to the invention, which in particular comprises two structurally identical flux collection elements, which advantageously each comprise a first collection zone and a second collection zone such that the second collection zones serve as a magnetic field reversal zone for a magnetic field applied by a magnetosensitive sensor element of the collector unit in relation to an interference magnetic field. Advantageously, a more precise steering system can thus be provided cost-effectively.

Further advantageous details, features and embodiment details of the invention are explained in greater detail in conjunction with the exemplary embodiments shown in the figures, in which:

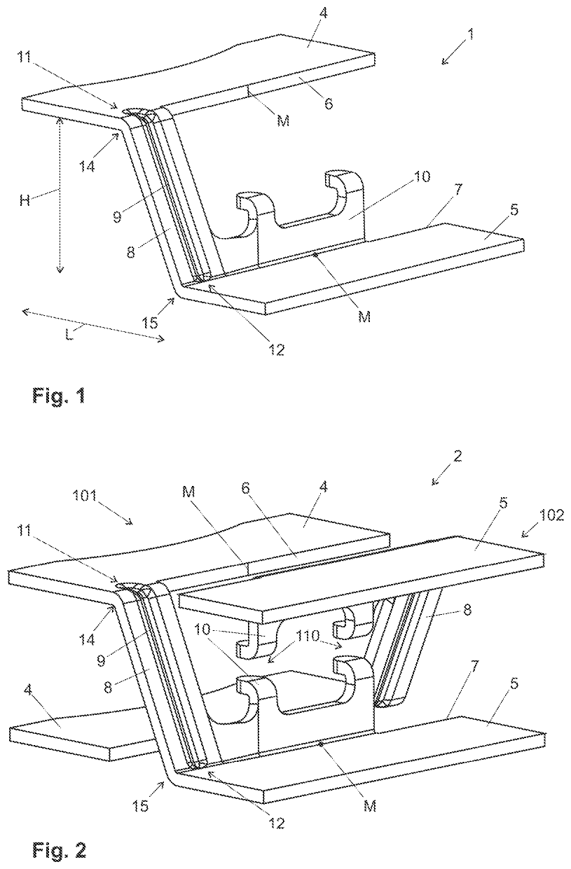

FIG. 1 shows a perspective view of an exemplary embodiment of a flux collection element formed according to the invention;

FIG. 2 shows a perspective view of an exemplary embodiment of a collector unit formed according to the invention;

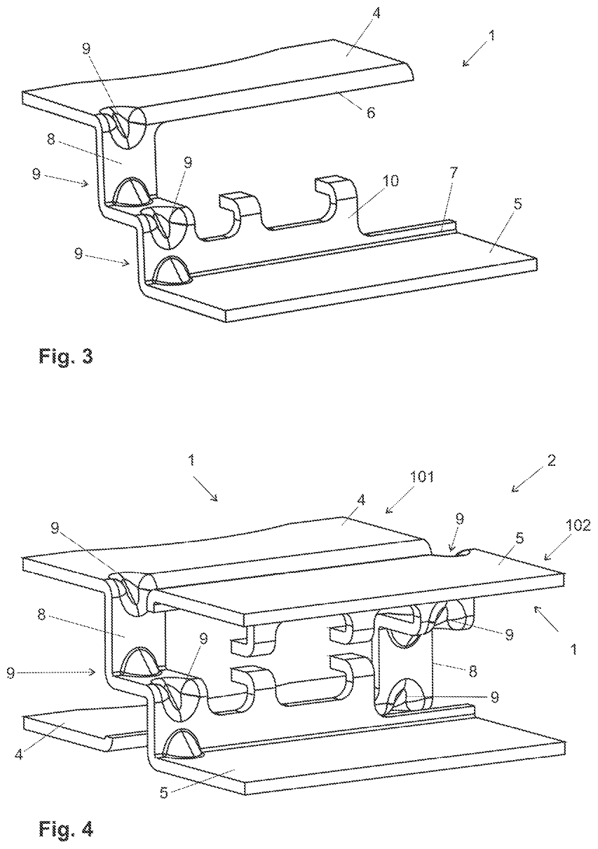

FIG. 3 shows a perspective view of a further exemplary embodiment of a flux collection element formed according to the invention;

FIG. 4 shows a perspective view of a further exemplary embodiment of a collector unit formed according to the invention;

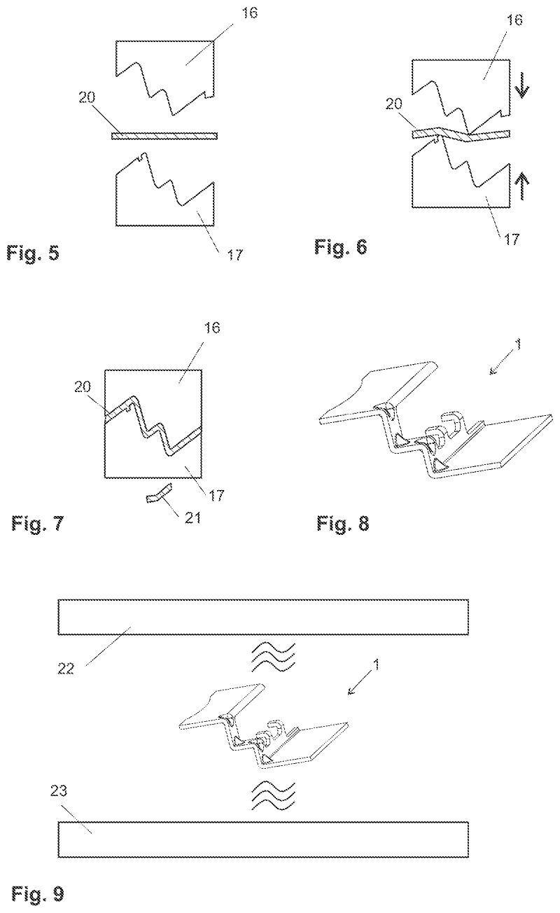

FIG. 5 to FIG. 9 show, in a schematic representation, an exemplary embodiment for a process sequence for producing a flux collection element according to a method according to the invention;

FIG. 10 shows, in a side view, an exemplary embodiment for a magnetic position sensor formed according to the invention;

FIG. 11 shows, in a side view, a further exemplary embodiment for a magnetic position sensor formed according to the invention;

FIG. 12 shows, in a simplified perspective view, an exemplary embodiment of a steering system formed according to the invention; and

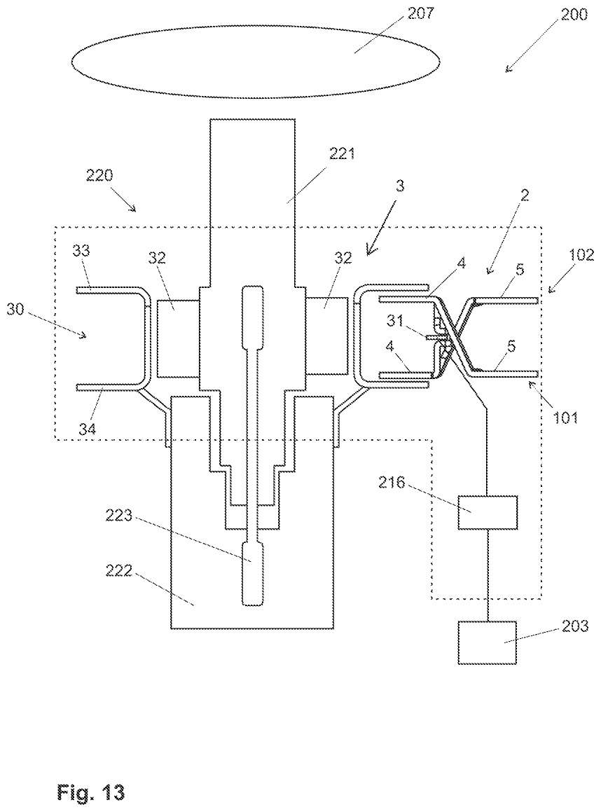

FIG. 13 shows, in a highly simplified schematic representation, details of the steering system according to FIG. 12, showing a further exemplary embodiment of a position sensor according to the invention, comprising an exemplary collector unit formed according to the invention and exemplary flux collection elements formed according to the invention.

In the various figures, like parts are generally provided with like reference signs and are therefore sometimes only explained in conjunction with one of the figures.

FIG. 1 shows an exemplary embodiment of a flux collection element 1 for a collector unit of a magnetic position sensor. The flux collection element 1 is made from a soft-magnetic sheet metal by a reshaping process and is formed in one piece. The flux collection element 1 comprises a first collection zone 4, which is arranged in a first plane, and a second collection zone 5, which is arranged in a second plane. The first plane is, in this case, a different plane from the second plane, but is arranged parallel to the second plane, which means that there is a height offset H between the first collection zone 4 and the second collection zone 5. The size of the first collection zone 4 corresponds at least approximately to the size of the second collection zone 5.

The flux collection element 1 also comprises a connection portion 8, which establishes a connection between the first collection zone 4 and the second collection zone 5. The connection portion 8 extends here diagonally between a first attachment edge 6 of the first collection zone 4 and a second attachment edge 7 of the second collection zone 5. The first collection zone 4 and the second collection zone 5 are thus spaced apart by the connection portion 8 in the longitudinal direction L of the flux collection element 1. The second collection zone 5 therefore lies outside the vertical projection surface of the first collection zone 4.

The connection between the first collection zone 4 and the second collection zone 5 is mechanically reinforced by introducing a bead 9 into the connection portion 8, which bead extends as a channel-shaped depression in the direction of the first collection zone 4 via the first attachment edge 6 into a first attachment region 11 of the first collection zone 4 and extends in the direction of the second collection zone 5 via the second attachment edge 7 into a second attachment region 12 of the second collection zone 5. This achieves a high degree of stability, which makes it possible to handle the flux collection element 1 as a bulk product without the collection zones 4, 5 bending relative to each other. In particular, the bead 9 prevents the first collection zone 4 from bending along the first attachment edge 6 and the second collection zone 5 from bending along the second attachment edge 7. In this exemplary embodiment, the bead 9 is positioned centrally with respect to the width of the connection portion 8.

In this exemplary embodiment, the connection portion 8 has a constant width which corresponds to approximately 15% to 20% of the length of the attachment edges 6, 7, wherein the length of the first attachment edge 6 is equal to the length of the second attachment edge 7. In this exemplary embodiment, the width of the connection portion 8 extends with respect to the first collection zone 4, starting from a first end 14 of the first attachment edge 6 to a point that lies significantly in front of the center position M of the first attachment edge 6. In relation to the second collection zone 5, the width of the connection portion 8 extends from a second end 15 of the second attachment edge 7 to a point that lies clearly in front of the center position M of the second attachment edge 7. The connection portion 8 is thus asymmetrical with respect to the center position M of the first attachment edge 6 and the center position M of the second attachment edge 7. This ensures that a collector unit can be easily created with the flux collection element 1 together with another structurally identical flux collection element. For this purpose, the flux-collection element 1 has a receiving unit 10 next to the connection portion 8, so that a collector unit can receive at least one magnetosensitive sensor element above it, with which a magnetic flux conducted by the collector unit can be detected.

FIG. 2 shows a perspective view of an exemplary embodiment of a collector unit 2 comprising a first flux collection element 101 and a second flux collection element 102. The first flux collection element 101 and the second flux collection element 102 are structurally identical and are designed as described with reference to FIG. 1. The second flux collection element 102 is rotated here by 180° relative to the first flux collection element 101 by rotating the second flux collection element 102 about its longitudinal axis. The first flux collection element 101 and the second flux collection element 102 are also arranged relative to one another in such a way that the first collection zone 4 of the first flux collection element 101 and the first collection zone 4 of the second flux collection element 102 overlap one another, i.e., the first collection zone 4 of the second flux collection element 102 lies in the vertical projection surface of the first collection zone 4 of the first flux collection element 101. The same applies accordingly to the second collection zones 5 of the flux collection elements 101, 102, which also overlap accordingly.

In addition, the receiving units 10 of the flux collection elements 101, 102 together form two receptacles 110, into each of which a Hall element can be inserted.

The receptacles 110 are arranged between the first collection zones 4 and the second collection zones 5 in such a way that the second collection zones 5 form a magnetic field reversal zone in relation to the first collection zones when a magnetic field acts on both the first collection zones 4 and the second collection zones 5. In this respect, the collector unit 2 is a stray-field-resistant collector unit.

FIG. 3 shows a further exemplary embodiment of a flux collection element 1 of a collector unit of a magnetic position sensor. The flux collection element 1 is produced from a soft-magnetic sheet metal by a bending-and-stamping operation and comprises a first collection zone 4, which is arranged in a first plane, and a second collection zone 5, which is arranged in a second plane, as also in the exemplary embodiment explained with reference to FIG. 1. Compared to the flux collection element 1 according to the exemplary embodiment explained with reference to FIG. 1, the connection portion 8 of the flux collection element 1 is designed differently. Thus, the connection portion 8 of the flux collection element 1 comprises a horizontal portion, which runs parallel to the collection zones 4, 5, and two portions aligned vertically to the collection zones 4, 5, via which the connection portion 8 is connected to the first collection zone 4 and the second collection zone 5.

The flux collection element 1 has a bead 9 at each reshaping point from the first collection zone 4 via the connection portion 8 to the second collection zone 5 for mechanical reinforcement. This means that the transition region between the first collection zone 4 and the connection portion 8 has a bead 9, the transition region between the second collection zone 5 and the connection portion 8 has a bead 9, and the connection portion 8 has a bead 9 in the transition region from the vertical portion to the horizontal portion and from the horizontal portion to the vertical portion. The reinforcement is thus arranged in particular in the form of a bead 9 within the first attachment edge 6 and within the second attachment edge 7, and beads 9 are provided in the connection portion 8 for mechanical reinforcement.

FIG. 4 shows a further exemplary embodiment for a collector unit 2 of a magnetic position sensor with a first flux collection element 101 and a second flux collection element 102, both of which are structurally identical. The flux collection elements 101, 102 each comprise, as in the exemplary embodiment according to FIG. 3, a first collection zone 4 in a first plane and a second collection zone 5 in a second plane.

In addition, the flux collection elements 101, 102 shown in FIG. 4 each have a connection portion 8, which connects the first collection zone 4 and the second collection zone 5 to one another magnetically conductively.

The first flux collection element 101 and the second flux collection element 102 of the collector unit 2 are aligned differently here, in such a way that the first collection zone 4 of the first flux collection element 101 covers the first collection zone 4 of the second flux collection element 102 and the second collection zone 5 of the first flux collection element 101 covers the second collection zone 5 of the second flux collection element 102, as shown in FIG. 4.

FIG. 5, FIG. 6 and FIG. 7 illustrate the method according to the invention for producing a flux collection element by means of a bending-and-stamping operation. FIG. 5 illustrates the provision of the blank, the sheet-metal element 20, between the tool halves 16, 17. After the intermediate step, during the closing of the tool halves 16, 17 as shown in FIG. 6, FIG. 7 illustrates the complete driving together of the tool halves 16, 17 and the resulting reshaping of the sheet-metal element 20 and the punching out of punching waste 21.

FIG. 8 then shows a flux collection element 1 produced by this method, wherein the beads of the flux collection element 1 have, in particular, also already been introduced in the method step shown in FIG. 7.

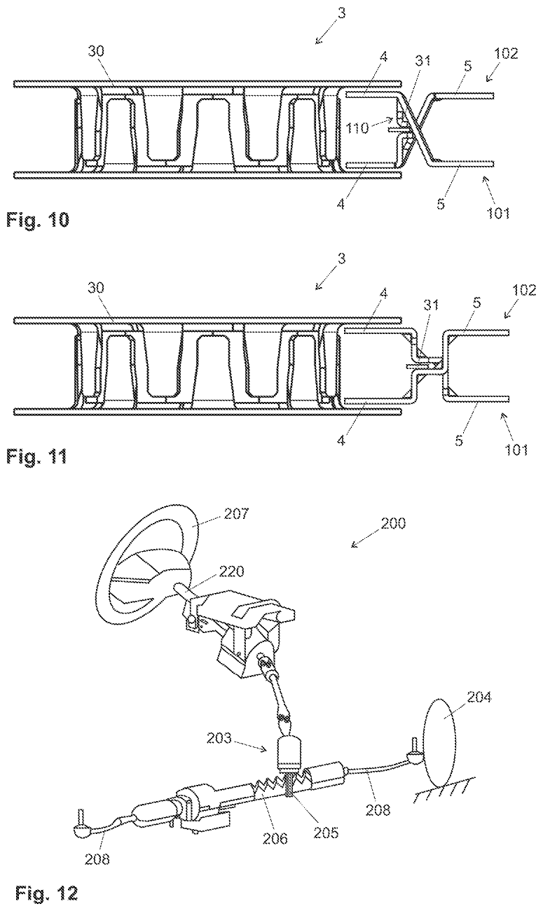

In a further step, the flux collection element 1 shown in FIG. 8 is introduced into a furnace 22, 23 and subjected to an annealing temperature, which in this exemplary embodiment is approximately 1150° C., as illustrated in FIG. 9. The wavy lines in FIG. 9 symbolize the heat effect on the flux collection element 1.

FIG. 10 and FIG. 11 each show an exemplary embodiment of a magnetic position sensor 3. In both exemplary embodiments, the magnetic position sensor 3, which can also be used in particular to determine a torque, comprises a stator ring element 30, a multi-pole magnetic ring, which is covered by the stator ring element 30 in FIG. 10 and FIG. 11, and a collector unit 2 with a Hall sensor 31. In the exemplary embodiment according to FIG. 10, the collector unit 2 is designed like the collector unit 2 explained with reference to FIG. 2. In the exemplary embodiment according to FIG. 11, the collector unit 2 is designed like the collector unit 2 explained with reference to FIG. 4.

Depending on how the stator ring element 30 is arranged in relation to the magnetic ring, a different magnetic flux is formed across the first collection zones 4 of the collector unit 2. In addition, interference magnetic fields, such as the earth's magnetic field, may also act on the first collection zone 4. However, these interference magnetic fields act in at least approximately the same way on the second collection zones 5 of the collector unit 2, albeit with the polarity reversed. This is because, due to the height offset between the first collection zone 4 and the second collection zone 5 of a flux collection element 101, 102 and the arrangement position of the Hall sensor 31, a magnetic field between the first collection zones 4 is detected with a different polarity than a magnetic field between the second collection zones 5.

Since the second collection zones 5 thus act like a magnetic field reversal zone, the Hall sensor 31 substantially only detects the useful magnetic field emanating from the magnetic ring.

Interference magnetic field components are detected at most at a significantly reduced level.

With reference to FIG. 12 and FIG. 13, an exemplary embodiment of an electromechanical steering system 200 formed according to the invention for a motor vehicle, in particular for a passenger car, is explained below. FIG. 12 provides a general overview of the steering system 200. In FIG. 13, the steering shaft 220 of the steering system 200 is shown in greater detail.

The steering system 200 comprises a steering column with a steering shaft 220. The steering shaft 220 is mechanically coupled to the steerable wheels 204 of a motor vehicle via a steering gear 203. In this exemplary embodiment, the steering gear 203 comprises a pinion 205 and a toothed coupling rod 206, wherein the steering gear 203 serves to translate a rotational movement of the pinion 205 into a translational movement of the coupling rod 206 along its longitudinal axis. At the end of the steering shaft 220 facing a driver, a steering wheel is arranged for conjoint rotation as a steering handle 207 for inputting a steering command, wherein a driver can turn the steering handle 7 in a known manner for inputting a steering command. In this exemplary embodiment, the coupling rod 206, which moves linearly along its longitudinal axis, is mechanically coupled to a tie rod 208 on both sides of the motor vehicle. The tie rods 208 are in turn each mechanically coupled to the vehicle wheels 204. The steering gear 203 is thus designed to convert a steering command into a steering movement of the steerable wheels 204 of a motor vehicle, taking into account at least one input variable.

The steering system 200 for this purpose also comprises a magnetic torque sensor device, not explicitly shown in FIG. 12, for measuring a torque applied to the steering shaft 220 and a control unit, also not explicitly shown. A measurement signal detected by the torque sensor device is transmitted to the control unit, wherein the control unit is designed to provide the measurement signal processed by the control unit as an input variable to the steering gear 203 or a control unit (not shown in FIG. 12) assigned to the steering gear 203. The magnetic torque sensor device is designed in particular according to one of the exemplary embodiments shown in FIG. 10 and FIG. 11.

The arrangement of the torque sensor device is shown here in a simplified schematic representation in FIG. 13. The steering shaft 220 of the steering system 200 shown in FIG. 13 comprises an input shaft 221 connected for conjoint rotation to a steering handle 207 and an output shaft 222 connected to the input shaft 221 via a twistable torsion bar 223. Furthermore, the steering system 200 has a magnetic torque sensor device 3 for measuring a torque applied to the steering shaft 220. In this exemplary embodiment, the torque sensor device 3 comprises a multi-pole magnetic ring 32, which is connected for conjoint rotation to the input shaft 221, for generating a magnetic field. Furthermore, the torque sensor device 3 comprises a stator ring element 30, which is connected for conjoint rotation to the output shaft 222 and surrounds the magnetic ring 32, with a first stator sub-ring element 33 and a second stator sub-ring element 34 and a magnetic flux collector unit 2.

The collector unit 2 in this case comprises two structurally identical flux collection elements 101, 102, each with a first collection zone 4, a second collection zone 5 and a connection portion 8, in particular as explained with reference to FIG. 1, wherein the second flux collection element 102 is rotated by 180° relative to the first flux collection element 101. The first collection zones 4 detect a magnetic flux of the useful magnetic field emanating from the magnetic ring 32 and components of one or more external interference magnetic fields. The second collection zones 5 of the collector unit 2 only detect the components of one or more external interference magnetic fields. Due to the arrangement of the second collection zones 5 as magnetic field reversal zones to the first collection zones 4, the interference magnetic field components detected by the first collection zones 4 and the second collection zones 5 largely compensate each other.

A Hall sensor 31 held between the collection zones 4, 5 by a receptacle thus substantially only measures the magnetic flux of the useful magnetic field emanating from the magnetic ring 32. The Hall sensor 31 detects the magnetic flux here in particular in dependence on a change in the magnitude and/or the direction of the magnetic field strength, which is caused by a change in the position of the stator ring 30 relative to the magnetic ring 32. The measurement signal detected by the Hall sensor 31 is transmitted to a computing unit 216 assigned to the torque sensor device 3. Based on the measurement signal received, the computing unit 216 generates an input variable for controlling the steering gear 203 of the steering system 200.

The exemplary embodiments shown in the figures and explained in conjunction therewith serve to illustrate the invention and are not limiting with respect thereto.

### LIST OF REFERENCE SIGNS

1 flux collection element
2 collector unit
3 magnetic position sensor
4 first collection zone
5 second collection zone
6 first attachment edge
7 second attachment edge
8 connection portion
9 bead
10 receiving unit
11 first attachment region
12 second attachment region
14 first end of the first attachment edge (6)
15 second end of the second attachment edge (7)
16 tool half
17 tool half
20 sheet-metal element
21 punching waste
22 furnace part
23 furnace part
30 stator ring element
31 Hall sensor
32 magnetic ring
33 first stator sub-ring element
34 second stator sub-ring element
101 first flux collection element
102 second flux collection element
110 receptacle for a Hall element (31)
200 steering system
203 steering gear
204 wheel
205 pinion
206 coupling rod
207 steering handle
208 tie rod
216 computing unit
220 steering shaft
221 input shaft
222 output shaft
223 twistable torsion bar
H height offset
L direction of longitudinal extent of the flux collection element
M center position

1-16. (canceled)

17. A flux collection element of a collector unit of a magnetic position sensor comprising:
a first collection zone and a second collection zone, wherein the first collection zone is arranged in a first plane and includes a first attachment edge, and the second collection zone is arranged in a second plane and includes a second attachment edge, and wherein a connection between the first collection zone and the second collection zone includes a magnetically conductive connection portion between the first attachment edge and the second attachment edge, wherein the connection is mechanically reinforced.

18. The flux collection element of claim 17, wherein the connection portion is asymmetrical with respect to a center position (M) of the first attachment edge and a center position (M) of the second attachment edge.

19. The flux collection element of claim 17, wherein the first collection zone, the second collection zone and the connection portion are formed together in one piece.

20. The flux collection element of claim 19, wherein the connection is mechanically reinforced by a reshaping process.

21. The flux collection element of claim 17, wherein the entire flux collection element, comprising the first collection zone, the second collection zone and the connection portion, is produced by a reshaping process.

22. The flux collection element of claim 17, wherein the reinforcement is formed as at least one bead.

23. The flux collection element of claim 22, wherein the bead extends over the connection portion and over the first attachment edge into a first attachment region of the first collection zone and over the second attachment edge into a second attachment region of the second collection zone.

24. The flux collection element of claim 17, wherein the least one mechanical reinforcement is arranged within the reshaping edges of the flux collection element.

25. A method for producing a flux collection element comprising:
providing a sheet-metal element made of a soft-magnetic material; and
reshaping the provided sheet-metal element in a bending-and-stamping operation into the finished form of the flux collection element, wherein during the bending-and-stamping operation at least one bead is introduced as strengthening into one of the surfaces and/or one of the bent portions of the flux collection element.

26. The method of claim 25, further comprising annealing the sheet-metal element at a temperature that neutralizes a magnetic structure of the reshaped sheet-metal element.

27. A collector unit of a magnetic position sensor, comprising:
a first flux collection element and a second flux collection element, wherein the first flux collection element and the second flux collection element are formed as claimed in claim 17 and/or are produced by a method of claim 25.

28. The collector unit of claim 27, wherein the first flux collection element and the second flux collection element are structurally identical.

29. The collector unit of claim 27, wherein the connection portion of the first flux collection element and of the second flux collection element are asymmetrical with respect to a center position (M) of the first attachment edge and a center position (M) of the second attachment edge.

30. The collector unit of claim 27, wherein the first flux collection element and the second flux collection element are rotated by 180° with respect to a direction of longitudinal extent (L) of the flux collection elements relative to one another.

31. A magnetic position sensor comprising:
a multi-pole magnetic ring;
a stator ring element; and
at least one magnetosensitive sensor element and a collector unit of claim 27.

32. An electromechanical steering system comprising:
a steering shaft, via which a steering command can be specified by means of a steering handle;
a steering gear, configured to convert a steering command into a steering movement of steerable wheels of a motor vehicle, taking into account at least one input variable; and
a magnetic torque sensor device for measuring a torque applied to the steering shaft, wherein the steering shaft comprises an input shaft configured to be connected for conjoint rotation to a steering handle and an output shaft connected to the input shaft via a torsion bar that capable of being be twisted, wherein the torque sensor device further comprises a multi-pole magnetic ring, connected to the input shaft for conjoint rotation, for generating a magnetic field, a stator ring element, which is connected to the output shaft for conjoint rotation and surrounds the magnetic ring, a magnetic flux collector unit and at least one magnetosensitive sensor element, wherein the at least one magnetosensitive sensor element is configured to provide a measurement signal based on a magnetic field applied to the magnetic flux collector unit, wherein the magnetic flux collector unit is a collector unit of claim 27.
